(19) United States
(12) Patent Application Publication
(10) Pub. No.: US 2014/0366071 A1
(43) Pub. Date: Dec. 11, 2014

(54) METHOD AND APPARATUS FOR QAM MODULATOR CHANNEL DUPLICATION

(71) Applicants: Steven Charles Rhoads, Carmel, IN (US); Douglas Paul Strachota, Indianapolis, IN (US)

(72) Inventors: Steven Charles Rhoads, Carmel, IN (US); Douglas Paul Strachota, Indianapolis, IN (US)

(73) Assignee: THOMSON LICENSING, Issy de Moulineaux (FR)

(21) Appl. No.: 14/345,173

(22) PCT Filed: Sep. 12, 2012
(86) PCT No.: PCT/US12/54744

§ 371 Date: Mar. 14, 2014

Related U.S. Application Data
(60) Provisional application No. 61/539,535, filed on Sep. 27, 2011.

(51) Int. Cl. H04N 21/235; H04N 21/436

(52) U.S. Cl. CPC H04N 21/235; H04N 21/436
USPC 725/78

(57) ABSTRACT

A content distribution system allows multiple channels to be played on multiple TV sets without the need to separately tune the TV sets using a remote control, which would potentially interfere with the channels being broadcast on nearby TV sets in an environment. A modulator dynamically duplicates the output of channels, thereby allowing multiple TV sets to be statically tuned to a fixed channel. The modulator can then duplicate the output so that a single input MPEG-2 transport stream can be sent out multiple channels and sub-channels to each of the desired TV sets.

### RELATED APPLICATIONS

This invention claims the benefit under 35 U.S.C. §119(a) of U.S. provisional patent application Ser. No. 61/539,535 filed on Sep. 27, 2011 entitled METHOD AND APPARATUS FOR QAM MODULATOR CHANNEL DUPLICATION, the teachings of which are specifically incorporated herein by reference.

### FIELD OF THE INVENTION

The present invention relates to modulators, and quadrature amplitude modulated (QAM) signals and the use of QAM modulators. More specifically, the present invention relates to the dynamic modification of QAM signals for use with a transport stream, for example an MPEG-2 transport stream, so that multiple QAM channels can be sent to multiple video display devices with a single transport stream from a QAM modulator.

### BACKGROUND OF THE INVENTION

There are many environments where multiple video display devices, for example televisions (TV) exist, but a few tuners/receivers are in place to send audio and video to the TVs. Sports bars are a prime example of such an environment, but many others such examples are extant, especially when it is desired to send different channels or subchannels to different places in an environment, but to save cost, only a limited number of receivers are provided.

In the sports bar environment, for example, bartenders want to be able to control the content on each TV without having to use single or multiple TV remotes, since using a TV remote may cause adjacent TVs to also change channels. Using a remote in a sports bar thus now requires walking to each TV with a specific remote to change the channel, which may cause other nearby TVs to also change channels.

One such receiver, although there are many such receivers, which is often placed in a multiple TV environment such as a sports bar is the DirecTV® COM1000 content distribution system (designed and manufactured by TECHNICOLOR Inc., the owner of the present application and invention), which is a satellite TV receiver system capable of tuning and transcrypting up to 24 TV channels and which tunes and demodulates an MPEG-2 transport stream for further distribution in an environment through, for example, a QAM modulator device or an internet protocol (IP) data distribution system, for example an IPTV system. The DirecTV® COM1000 is ideal for the multiple TV environment such as hotels, sports bars, and the like.

The DirecTV® COM1000 includes a QAM modulator card or board which receives the demodulated MPEG-2 transport stream for further distribution. The card is denoted a QAM24 modulator and it receives MPEG-2 transport packets from an Ethernet port and then QAM modulates the MPEG-2 transport packets on one of twelve carrier frequencies. Each input stream results in one output QAM modulated channel (such as cable channel 50-1). However, nothing in the current content distribution systems allows individual receivers to play separate content on each TV without controlling the content with a separate remote for each TV.

It would be desirable to design a system which permits separate playing and control of content in a multiple TV environment without the use of a remote control for each TV. Such needs have not heretofore been fulfilled in the art.

### SUMMARY OF THE INVENTION

The content distribution system of the present invention allows multiple television programs and channels to be output to multiple TV sets in an environment, thereby eliminating the need for remote controls to be used to change channels and potentially interfere with neighboring TV sets. The present invention permits a modulator to dynamically duplicate the output of channels, thereby allowing multiple TV sets to each be statically tuned to a fixed channel. The modulator can then duplicate the output so that a single input MPEG-2 transport stream can send out multiple channels and sub-channels to each of the desired TV sets.

To accomplish these results, systems and methods in accordance with the invention are provided. Systems for displaying content comprise a receiver for receiving data from a source and outputting a transport stream having data packets therein; a modulator that modulates the transport stream on a frequency to produce a plurality of output channels that may be statically tuned to a corresponding plurality of fixed channels to allow different output to be received by separate devices; a buffer for receiving the data packets in response to a direct memory access request; and a processor for creating a descriptor for a group of transport packets received in response to the direct memory access request and indicating which of the fixed channels the content will be statically tuned to for output to one of the devices.

Methods of displaying content in accordance with the invention comprise the steps of copying packetized data received from a medium and determining whether the packetized data appears on a list of data transfer requests; adding a data transfer request to the list when it is determined that a data packet that has been copied does not correspond to a current data transfer request to create an updated data transfer list; and forwarding the data packets in accordance with the updated data transfer list for display.

The invention will be best understood by reading the following detailed description of the preferred embodiments thereof in conjunction with the drawings which are first described briefly below.

### BRIEF DESCRIPTION OF THE DRAWINGS

FIG. 1 is a block diagram of a content distribution system in accordance with the present invention.

FIG. 2 is a block diagram of a preferred embodiment of a content distribution system and modulator in accordance with the present invention utilizing inventive DMA processes.

FIG. 3 is a flow chart of a preferred method provided in accordance with the present invention.

### DETAILED DESCRIPTION OF PREFERRED EMBODIMENTS

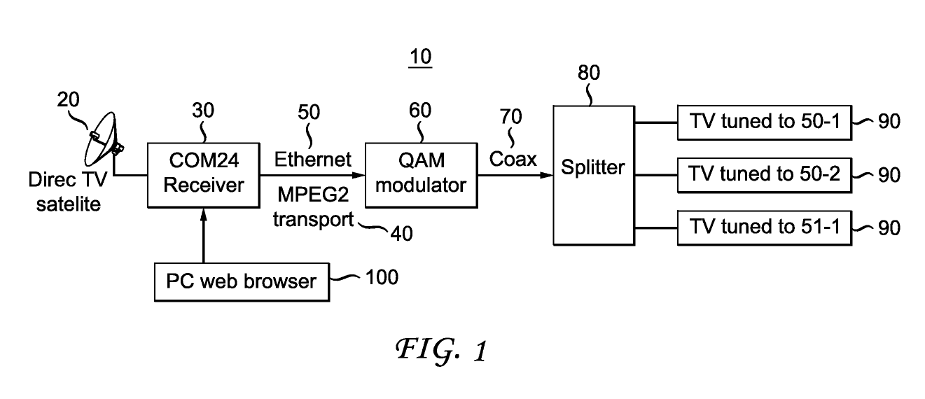

Referring now to the Figures wherein like reference numerals refer to like elements, in FIG. 1 a preferred embodiment of a content distribution system according to the invention is shown at 10. A satellite downloads a signal 20 which is input to a receiver 30 that demodulates the signal and produces an MPEG-2 transport stream 40 having packets, preferably user datagram protocol (UDP) packets, containing data and video programming to be distributed to the environment. The MPEG-2 transport stream 40 is preferably transported by an Ethernet link 50 to a QAM modulator 60 which modulates the MPEG-2 transport stream 50 in accordance with principle s of the present invention. While preferred embodiments of the invention utilize QAM modulators and MPEG-2 transport streams, it will be appreciated by those skilled in the art that other kinds of modulators are equally usable and many different types of transport protocols are also usable. Therefore, VSB modulators, QPSK modulators, OFDM modulators, and their equivalents are all covered by the current invention. Moreover, IP signaling transport streams, DVB transport streams, MPEG-4 transport streams, ARIB transport streams, and their equivalents are also covered by the invention.

Preferably, the QAM modulator 60 modulates the MPEG-2 transport stream 40 on one of twelve carrier frequencies. Each input stream 40 results in an output QAM modulated channel which is output over a coax cable 70 and split with a splitter 80. In this fashion, the QAM modulator 60 permits dynamic duplication of output channels so that each TV 90 may be statically tuned to a fixed channel, for example, channels 50-1, 50-2, 50-3, etc., thereby eliminating the necessity for each channel to be individually tuned with a separate remote and allowing different programs to be played on different TV sets 90 without interference from other, nearby TV sets being tuned with a remote control to provide different desired programs. Optionally, a PC web browser 100 is provided interfaced to the receiver 30 to control the data programming necessary to accomplish these results and to provide other functionality to perform the functions of content distribution system 10.

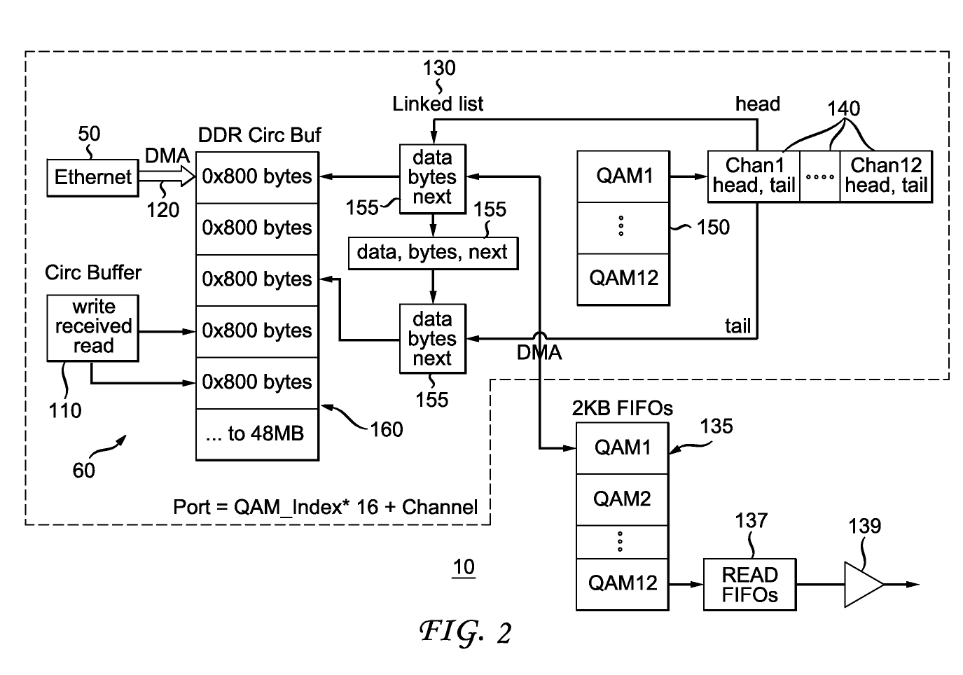

Referring to FIG. 2, the QAM modulator 60 supports 12 QAM streams 150 with up to 12 video channels per QAM stream. Each of the video channels 140 can have a bitrate of 20 Mbps with up to 500 ms of jitter that must be buffered. If a separate FIFO is used for each channel the memory buffer requirements are: 144 channels*20 Mbps*0.5 seconds/8 BitsPerByte=180 MB of buffering memory. However, it will be recognized that distributed systems typically are buffer limited and therefore only have limited memory capacities. The exemplary COM100 system only has 64 MB of DDR memory. Using a separate FIFO for each channel also requires that every transport packet be copied into the FIFO and then be copied out of the FIFO.

In order to overcome these issues, the inventive system 10 utilizes a new buffering model which reduces the amount of memory required for buffering and reduces the CPU load required to move the transport packets. When the Ethernet packets are received at an input port of modulator 60 they are automatically placed into a single circular buffer 110 by the Ethernet direct memory access (DMA) 120. Instead of then copying the transport packets into separate FIFOs based on the video channel, the transport packets are left in the common circular buffer 110. A descriptor 155 is created for each group of transport packets in a UDP packet. The descriptor indicates the memory location(s) 160 and number of bytes of the transport packets in the common circular buffer 110.

Instead of immediately moving the transport packets into a FIFO, the descriptors are placed in a linked list 130. This permits the common circular buffer 110 to be used as a jitter buffer for all channels 140. Since the maximum data rate of a QAM256 stream is 38.8 Mbps, the buffer memory requirements are: 12 QamStreams*38.8 Mbps/QamStream*0.5 seconds/8 BitsPerByte=29.1 MB of DDR memory. This solution also reduces how many times the transport packets must be copied since the packets do not have to be copied into separate per channel FIFOs.

Giving the QAM modulator 60 the ability to duplicate channels allows a single MPEG-2 transport packet to appear at multiple QAM frequencies, and further allows for multiple sub-channels to be statically tuned to a fixed digital cable channel on each TV 90. The COM24 receiver 30 can then be commanded to tune to a DirecTV channel (if, e.g., DirecTV is the service provider, but other providers may also be accessed) and to output an IP encapsulated MPEG-2 transport stream to the QAM modulator 60.

The input 40 to the QAM modulator 60 is a single program transport stream (SPTS) but the output of the QAM modulator 60 is a multiple program transport stream (MPTS) that is QAM modulated. This requires PID remapping and creation of a unique Program Map Table (PMT) for each channel to define the PIDs for each channel. The QAM modulator's input UDP port directly controls which QAM channel and sub-channel that is output.

Duplicating an input channel requires modifying the packet PIDs for each different output, and creating a different PMT. It is preferable to use a DMA to transfer a packet to a QAM modulation block. After the DMA is completed, the packet is then scheduled for another DMA to a different QAM modulation block as if that packet had also been received from the Ethernet connector on a different UDP port. This permits the packets to be “chained” in the linked list 130 from one UDP input port to the next UDP input port until the input channel has been duplicated the desired number of times.

The system 10 thereby implements a process which allows multiple TV receivers to be each statically set so that remote controls need not be used to change the programs for each TV. In order to accomplish this result and implement the DMA transfers of FIG. 2, first the UDP packets containing MPEG-2 transport packets are read from the Ethernet MAC by using the receive DMA engine to copy the Ethernet packets to main memory in circular buffer 110. The CPU then analyzes the destination UDP port number to add new entries to the correct pending list of DMA requests 130. There is one linked list of pending DMA requests 130 for each sub-channel 140 (up to 12) for each QAM carrier 150 (up to 12) for a total of 144 possible linked lists of pending DMAs. The DMA engine uses a linked list 130 of pending DMA requests (stored in RAM block). The pending DMA requests place the packets into circular buffer FIFOs 135. The data in FIFOs 135 are then read at 137 by the QAM modulator 60, and sent to an A/D converter 139 for eventual output to the content receiving devices, for example TVs. While FIFOs and circular buffers are used in preferred embodiments, it will be appreciated by those skilled in the art that any type of buffer memory that is adaptable for storing DMA requests may be used in the inventive systems.

All completed DMA requests are then finalized, and the size of the Ethernet packet is remembered while a counter which keeps track of how many packets are in the circular buffer is incremented. New DMA requests are then taken from 130 and started. In a preferred embodiment, the linked list 130 contains descriptors pointing to packets that eventually need to be DMA'ed, but the DMA has not yet been scheduled. Additionally, there is a separate linked list of DMA requests (not shown in FIG. 2) that have been started but the DMA hardware has not yet completed.

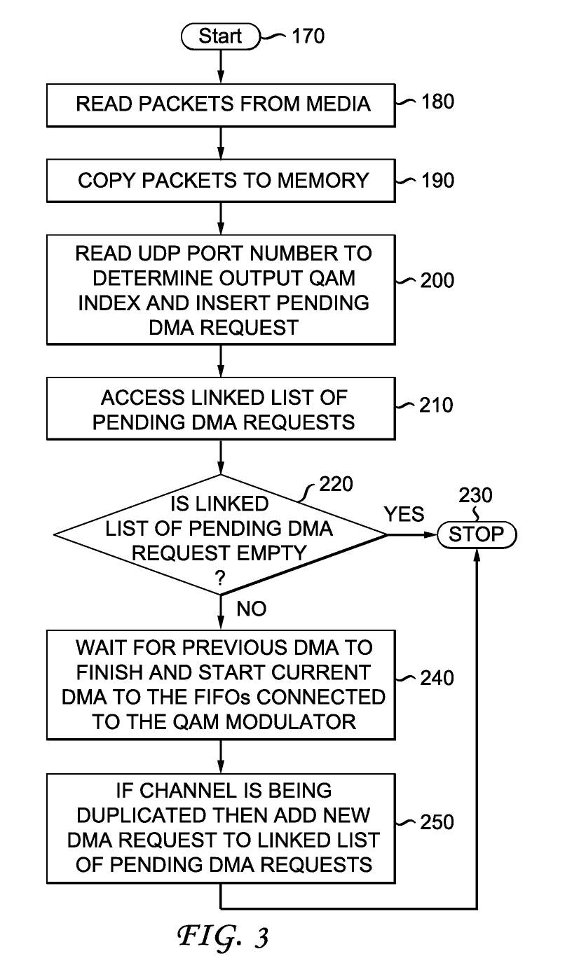

Referring to FIG. 3, a preferred method for assigning static channels or sub-channels in accordance with the invention begins at step 170. At step 180 the data packets are read from the media source, for example Ethernet port 50, but it will be recognized that other data sources may be used, for example the Internet, downloadable media, DVDs, Blu-ray discs, or other sources of packetized data. Additionally, it will also be appreciated that other than just video programs and content may be modulated and output in accordance with the invention. Data programs, games, computer programs, audio channels, wireless communications are all types of content which may be modulated and output in accordance with the invention. Moreover, many different types of devices other than video displays may receive the content. For example, audio receivers, computers, network devices, distributed networks and other devices and systems may also receive output modulated signals created in accordance with the invention.

At step 190, the data packets are copied to memory, preferably the circular buffer memory 110. At step 200 the destination UDP port number of the received UDP packet is read to determine the output QAM index and insert pending DMA requests. At step 210 the lists of pending DMA requests are accessed, and it is then determined at step 220 whether the linked list of pending DMA requests is empty. If so, then the method stops at step 230.

If however it is determined at step 220 that there is a current DMA request, then at step 240 the previous DMA requests must be finalized and the data packets associated with the current DMA request are DMA'ed to the FIFOs 135 attached to the QAM modulator. At step 250, if the current channel is being duplicated then the additional DMA requests are then added as new DMA requests to the linked list 130 of pending DMA requests and the method stops at step 230. Similarly, the packets associated with each of the DMA requests stored according to the linked list are output from the QAM modulator 60.

It will be further appreciated by those with skill in the art that QAM modulator 60 comprises a central processing unit (CPU) which is adapted to perform, among other necessary data processing and steps, the necessary steps taught herein to accomplish preferred embodiments of the invention. When performing these necessary steps, the CPU acts as a special purpose computer specifically programmed to perform these steps and functions.

The CPU of the QAM modulator 60 (preferably a Nios II CPU) analyzes the next Ethernet packet in the circular buffer 110 to determine the packet type and place MPEG-2 transport packets into the correct linked list 130 by analyzing the destination UDP port number. UDP packets with port 0x200-0x2ff are used to control the EdgeQam of QAM modulator 60 and query its status.

The UDP packets with port QamIndex*16+ChannelIndex contain MPEG-2 transport packets which are 188 bytes long. Up to seven MPEG-2 transport packets are in each UDP packet. The MPEG-2 transport packets are placed into linked lists 130. Each of the 12 QAM streams contains an array of 12 channels. Each channel has a linked list of MPEG-2 packets. There is a bitmap (12-bit integer) of which QAM stream has pending packets. Within a QAM stream there is a bitmap of which channels have pending packets.

The Nios II CPU looks at which FIFOs have space available and which linked lists have data and then schedules a DMA request. There is a bitmap (12-bit integer) of which FIFOs have space available. Each QAM stream is given a chance to schedule a DMA before the first QAM stream is analyzed again and within a QAM stream each channel is given a chance to schedule a DMA before the first channel is analyzed again.

Looping through the QAM streams and channels prevents one QAM stream or channel from delaying the data from the other channels. The DMA requests then go into a linked list of pending DMA requests.

In a further preferred embodiment, PC 100 can send commands to either the COM24 receiver 30, which then sends commands to the QAM modulator 60, or the PC 100 can directly send commands to the QAM modulator 60 to dynamically change which MPEG-2 transport streams being received by the QAM modulator are duplicated and dynamically change the desired destination QAM carrier and sub-channels. A single input channel can be duplicated multiple times such that a single MPEG2 transport stream could be duplicated up to 23 times so that 24 different TVs (each statically tuned to a different virtual channel) would all display the same video content. For example, if a sports bar had six tuners/receivers but 24 TVs, the QAM modulator can then act like a switching matrix to control which input MPEG-2 transport stream is sent to which output virtual channel so that each TV can be statically tuned to a fixed channel.

The content distribution system of the present invention thereby allows multiple television programs and channels to be output to multiple TV sets in an environment, thereby eliminating the need for remote controls to be used to change channels and potentially interfere with neighboring TV sets. Using the inventive QAM modulator and DMA process, the present invention permits the modulator to dynamically duplicate the output of channels, thereby allowing multiple TV sets to be statically tuned to a fixed channel. The modulator can then duplicate the output so that a single input MPEG-2 transport stream can send out multiple channels and sub-channels to each of the desired TV sets.

There have thus been described certain preferred embodiments of content distribution systems in accordance with the present invention. While preferred embodiments have been described and disclosed in will appreciated by those with skill in the art that modification are within the true spirit and scope of the invention. The appended claims are intended to cover all such modifications.

1. A modulator comprising:
an input for receiving data packets corresponding to content;
a buffer for storing the data packets in response to a direct memory access request;
a descriptor module for creating descriptors for the packets stored in the buffer which indicate a location of each packet in the buffer and a length of each packet in the buffer;
a memory for storing the descriptors created by the module for each of the packets in the buffer in a list; and
an output for outputting the packets which are identified by the descriptors for further use of the content.

2. The modulator recited in claim 1, wherein the descriptor module comprises a copy block for copying the data packets to the buffer and determining whether the data packets appear on the list in the memory;

3. The modulator recited in claim 2, wherein the descriptor module comprises a data transfer bock for adding a data transfer request to the list when it has been determined that a data packet that has been copied by the copy block does not correspond to a current data transfer request and for creating an updated data transfer list.

4. The modulator recited in claim 3, wherein the descriptor module comprises a forwarding module for forwarding the data packets in accordance with the updated data transfer list for output.

5. A method of displaying content, comprising the steps of:
copying packetized data received from a medium and determining whether the packetized data appears on a list of data transfer requests;
adding a data transfer request to the list when it is determined that a data packet that has been copied does not correspond to a current data transfer request to create an updated data transfer list; and
forwarding the data packets in accordance with the updated data transfer list for output.

6. The method recited in claim 5, further comprising the step of creating a descriptor for each of the data packets which received from the medium to describe a length and location of each of the received data packets.

7. The method recited in claim 6, further comprising the step of storing each of the descriptors corresponding to each of the data packets on the list.

8. The method recited in claim 7, wherein the adding step further comprises the step of adding new descriptors to the list to create the updated list.

9. The method recited in claim 8, further comprising the step of forwarding the data packets for further use in accordance with the updated list.

10. A system for displaying content comprising:
a receiver for receiving data from a source and outputting a transport stream having data packets therein;
a modulator that modulates the transport stream on a frequency to produce a plurality of output channels that may be statically tuned to a corresponding plurality of fixed channels to allow different output to be received by separate devices;
a buffer for receiving the data packets in response to a direct memory access request; and
a processor for creating a descriptor for a group of transport packets received in response to the direct memory access request and indicating which of the fixed channels the content will be statically tuned to for output to one of the devices.

11. The system recited in claim 10, wherein the modulator comprises:
an input for receiving data packets corresponding to content;
a buffer for storing the data packets in response to a direct memory access request;
a descriptor module for creating descriptors for the packets stored in the buffer which indicate a location of each packet in the buffer and a length of each packet in the buffer;
a memory for storing the descriptors created by the module for each of the packets in the buffer in a list; and
an output for outputting the packets which are identified by the descriptors for further use of the content.

12. The modulator recited in claim 11, wherein the descriptor module comprises a copy block for copying the data packets to the buffer and determining whether the data packets appear on the list in the memory;

13. The modulator recited in claim 12, wherein the descriptor module comprises a data transfer bock for adding a data transfer request to the list when it has been determined that a data packet that has been copied by the copy block does not correspond to a current data transfer request and for creating an updated data transfer list.

14. The modulator recited in claim 13, wherein the descriptor module comprises a forwarding module for forwarding the data packets in accordance with the updated data transfer list for output.

15. The system recited in claim 14, wherein the output comprises a plurality of memory units for storing the descriptors corresponding to the data packets so that the data packets and the descriptors may be forwarded to output devices so that the output devices can statically receive the data packets.

16. The system recited in claim 15, further comprising a splitter in communication with modulator for splitting the data packets into a plurality of subchannels.

17. The system recited in claim 16, wherein the splitter splits the data packets into a plurality of sub-channels which can each be statically output to a content device.

18. The system recited in claim 17, wherein splitter splits the data packets into twelve sub-channels.

19. The system recited in claim 18, wherein the modulator comprises a quadrature amplitude modulator.

20. The system recited in claim 20 wherein the data packets comprise video data packets.
